(19) United States
(12) Patent Application Publication
(10) Pub. No.: US 2013/0176899 A1
(43) Pub. Date: Jul. 11, 2013

(54) METHOD FOR ACQUIRING STATION INFORMATION

(71) Applicant: Guang Ji, Hangzhou (CN)

(72) Inventor: Guang Ji, Hangzhou (CN)

(73) Assignee: Hangzhou H3c Technologies Co., Ltd., Hangzhou (CN)

(21) Appl. No.: 13/822,229

(22) PCT Filed: Sep. 23, 2011
(86) PCT No.: PCT/CN11/80104

§ 371 Date: Mar. 11, 2013

(30) Foreign Application Priority Data
Sep. 25, 2010 (CN) 201010290046.3

(51) Int. Cl. H04W 24/00

(52) U.S. Cl. CPC H04W 24/00
USPC 370/254

(57) ABSTRACT

A method for acquiring station information is disclosed. The method is for use in a system comprising an access controller (AC), a Fit Access Point (Fit AP), a station and a network management device. The method comprises: the network management device reading the station information under the AC when it is initialized, the network management device determining a new online duration of the station according to the recorded online duration of the station and the time interval since the last time the online duration was updated, and the network management device displaying and/or recording the new online duration of the station.

### BACKGROUND

With the extensive applications of wireless network, APs (Access Point) are increasingly applied, and in order to reduce costs, simplify management, and improve security, the networking mode of AC (Access Controller) plus Fit AP is used especially extensively. Adopting the networking mode of AC plus Fit AP can realize the centralized management of AP and Station by AC, which greatly facilitates the deployment of a network and has now become the mainstream wireless networking mode.

Under the centralized management of AC, a network management device acquires the data of a station under an AC via the AC device. In order to achieve the synchronization of the display of the network management device with the AC device and to achieve substantially real-time updating on the network management device, the network management device needs to interact with the AC relatively frequently. The network management device updates the station data by way of regular polling and alarm triggering, and the AC device sends performance data of the station under the AC to the network management device frequently. This causes the AC system to be busy, affects the performance of the AC, and even causes access failure of the Fit AP.

### DESCRIPTION OF DRAWINGS

FIG. 1 is a schematic diagram of a method for acquiring station information according to an example;

FIG. 2 is a schematic diagram of a method for acquiring station information according to another example;

FIG. 3 is a schematic diagram of a method for acquiring station information according to yet another example;

FIG. 4 is a schematic diagram of a method for acquiring station information according to yet another example;

FIG. 5 is a schematic diagram of a method for acquiring station information according to yet another example;

FIG. 6 is a schematic diagram of the online duration statistics of a station obtained by the method for acquiring station information;

FIG. 7 is a schematic diagram of the structure of a network management device according to an example;

FIG. 8 is a schematic diagram of the structure of a network management device according to another example;

FIG. 9 is a schematic diagram of the structure of a network management device according to yet another example; and

FIG. 10 is a schematic diagram of the structure of a network management device according to yet another example.

### DETAILED DESCRIPTION

In the present disclosure, a network management device determines new online duration of a station according to the recorded online duration of the station and the time interval since the last time the online duration was updated without needing to interact with the AC frequently to obtain the online duration of the station.

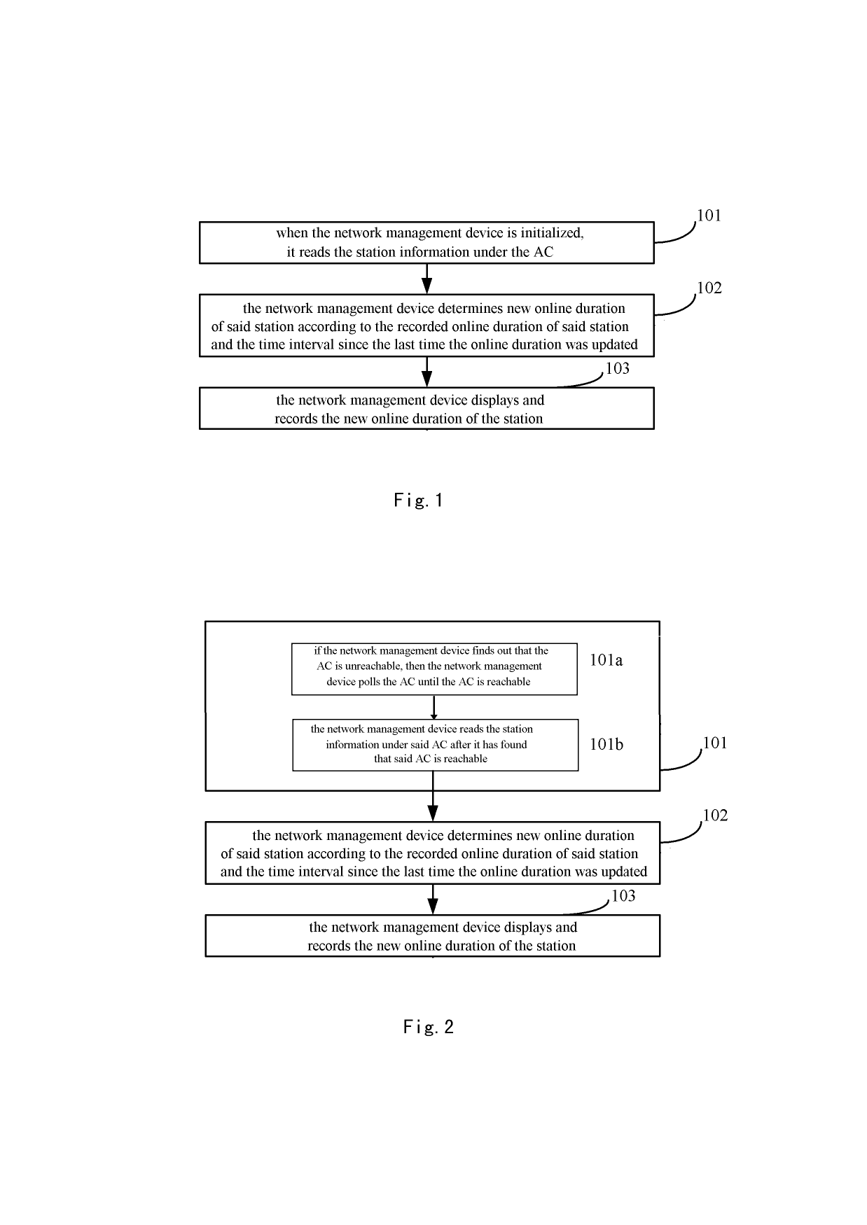

The present disclosure provides a method for acquiring station information according to an example as shown in FIG. 1, which is for use in a system comprising an AC, a Fit AP, a station and a network management device. The station may be wirelessly connected to the Fit AP which is managed by the AC. This method comprises:

Block 101, when the network management device is initialized, it reads the station information under the AC. Specifically, “when the network management device is initialized” refers to the moment when the AC joins the queue of managed devices of the network management device. The network management device reads all information under the AC when initialized, comprising AC basic information, AP information and station information.

Block 102, the network management device determines new online duration of said station according to the recorded online duration of said station and the time interval since the last time the online duration was updated.

After reading the information of the AC, the network management device records the read the online duration T1 of the station. A time interval G is set in the network management device. At intervals of time G, the network management device reads the recorded online duration T1 of the station and calculates new online duration T2 of the station according to the following formula: T2=T1+G, wherein the value of G can be set flexibly according to actual requirement. For example, when the real-time requirement of the online duration of the station is rather high, G can be set to a relatively small value, and when the real-time requirement of the online duration of the station is relatively low, G can be set to a relatively large value.

Block 103, the network management device displays and/or records the new online duration of the station. For example, the network management device uses the T2 obtained in block 102 to replace the online duration T1 of the station recorded by itself.

FIG. 2 shows a method for acquiring station information according to another example. This method is substantially same as the method shown in FIG. 1 except that block 101 further comprises sub-block 101a and 101b.

Sub-block 101a, if the network management device finds out that the AC is unreachable, the network management device polls the AC until the AC is reachable, or stops managing the AC when the number of times of polling reaches a threshold value.

Sub-block 101b, the network management device reads the station information under said AC after it has found that said AC is reachable.

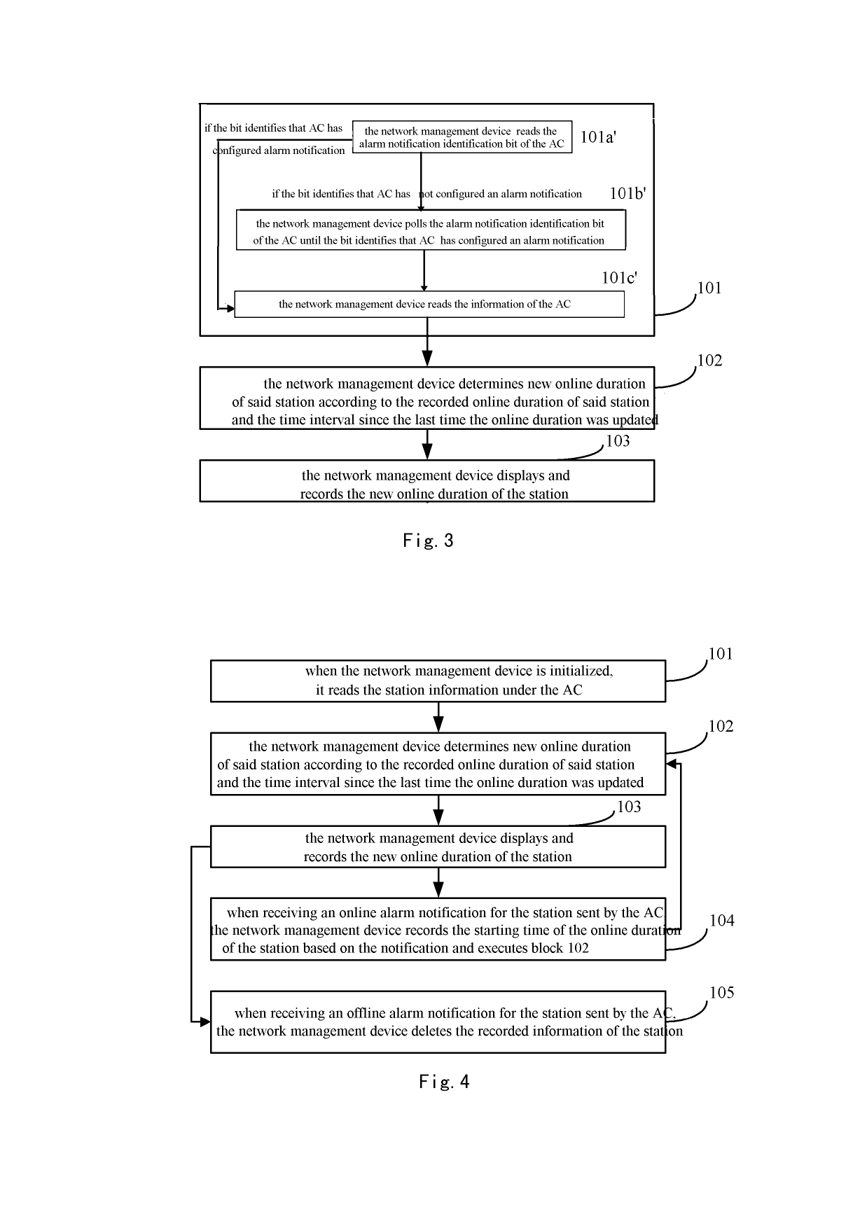

FIG. 3 shows a method for acquiring station information according to yet another example. In this example, the AC may configure an alarm notification identification bit for identifying whether said AC has configured an alarm notification, i.e. sending an alarm notification to the network management device when the station is getting online or offline. This method is substantially same as the method shown in FIG. 1 except that block 101 further comprises sub-block 101a′, 101b′ and 101c′.

Sub-block 101a′, the network management device reads the alarm notification identification bit of the AC.

Sub-block 101b′, if the alarm notification identification bit identifies that the AC has not configured an alarm notification, the network management device polls the alarm notification identification bit of the AC until the alarm notification identification bit identifies that the AC has configured an alarm notification.

Sub-block 101c′, if the alarm notification identification bit identifies that the AC has configured an alarm notification, the network management device reads the information of the AC.

FIG. 4 shows a method for acquiring station information according to yet another example. This method is substantially same as the method shown in FIG. 1 except that it further comprises block 104 and 105.

Block 104, when receiving an online alarm notification for the station sent by the AC, the network management device records the starting time of the online duration of the station based on the notification and executes block 102. Specifically, the online duration information of a plurality of stations is stored in the network management device. When the network management device reads the information of the AC, there could be a new station getting online or an old station getting offline under the AC before reading the information of the AC for the next time. At this time, the network management device receives an online alarm notification or an offline alarm notification sent by the AC. If an online alarm notification sent by the AC is received, the network management device determines the starting time of the online duration of the station based on said online alarm notification.

Block 105, when receiving an offline alarm notification for the station sent by the AC, the network management device deletes the recorded information of the station.

In the method provided by the present disclosure, sending an alarm notification by the AC to the network management device includes other situations, such as the channel change of a station, etc., in this case the network management device updates the stored channel of the station based on the alarm notification of the AC.

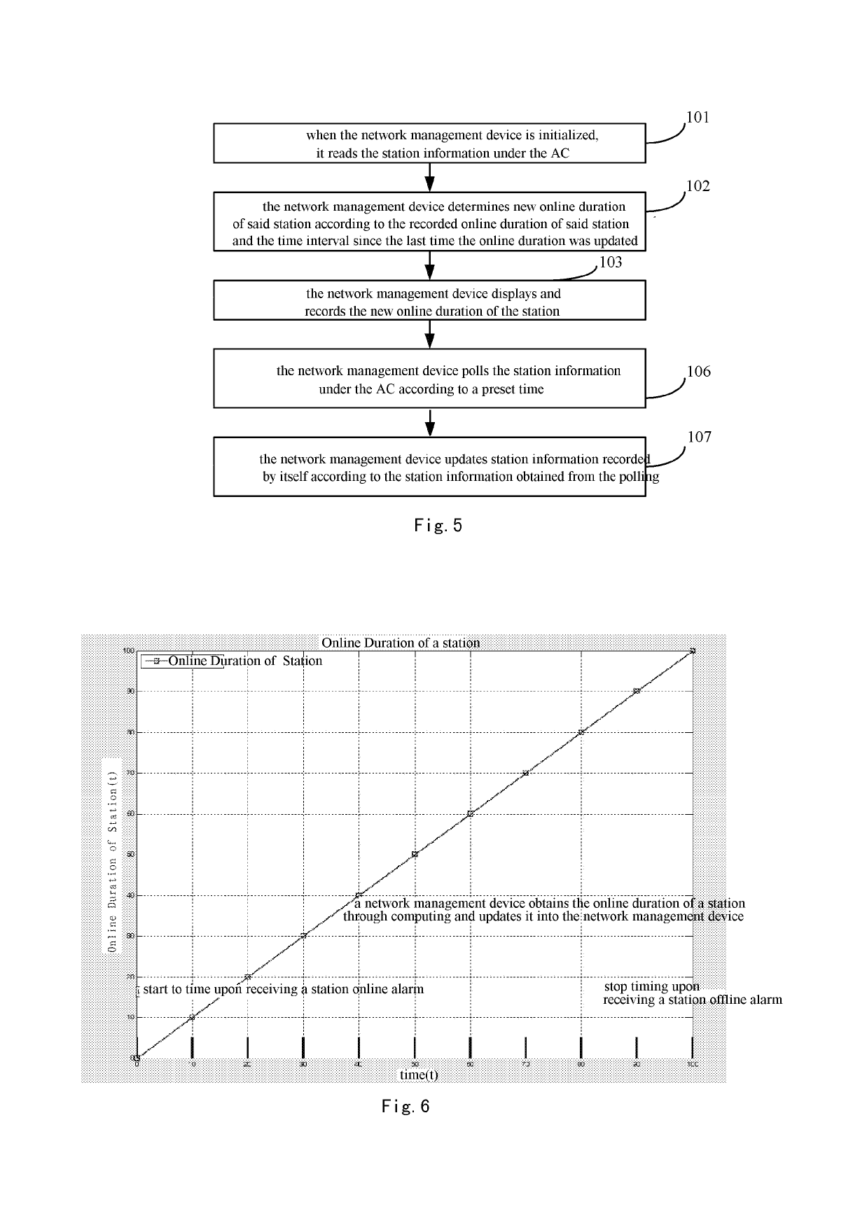

FIG. 5 shows a method for acquiring station information according to yet another example. This method is substantially same as the method shown in FIG. 1 except that it further comprises block 106 and 107.

Block 106, the network management device polls the station information under the AC according to a preset time.

Block 107, the network management device updates station information recorded by itself according to the station information obtained from the polling, wherein, the preset time is different from the polling period in the prior art. The polling period in the prior art is usually 5-10 minutes, while the preset time in the present disclosure is a longer time period as compared with that in the prior art, which is measured by the hour, e.g. 1 or 2 hours. With the polling of long time intervals proposed by the present disclosure, the loss of alarm notification caused by a busy network, which may result in error in station information recorded by the network management device, can be avoided. The network management device further updates online duration of a station recorded by itself based on the read station information. For example, after reading the information of an AC, the network management device finds out that online duration of a station is Ta, but the network management device per se does not store the online duration of the station, then the network management device updates the information of the station recorded by itself.

The statistics of online duration of a station obtained by using the method provided by the present disclosure is shown in FIG. 6, wherein the initial value of the online duration of the station may not be 0 (the online duration of the station is not 0 when the information of the station is read from the AC for the first time).

With the method for acquiring station information provided by the present disclosure, a network management device determines new online duration of a station according to the recorded online duration of the station and the time interval since the last time the online duration was updated without needing to interact with the AC frequently to obtain the online duration of the station, thus reducing the load on the AC and being beneficial in improving the Fit AP access capability of the AC.

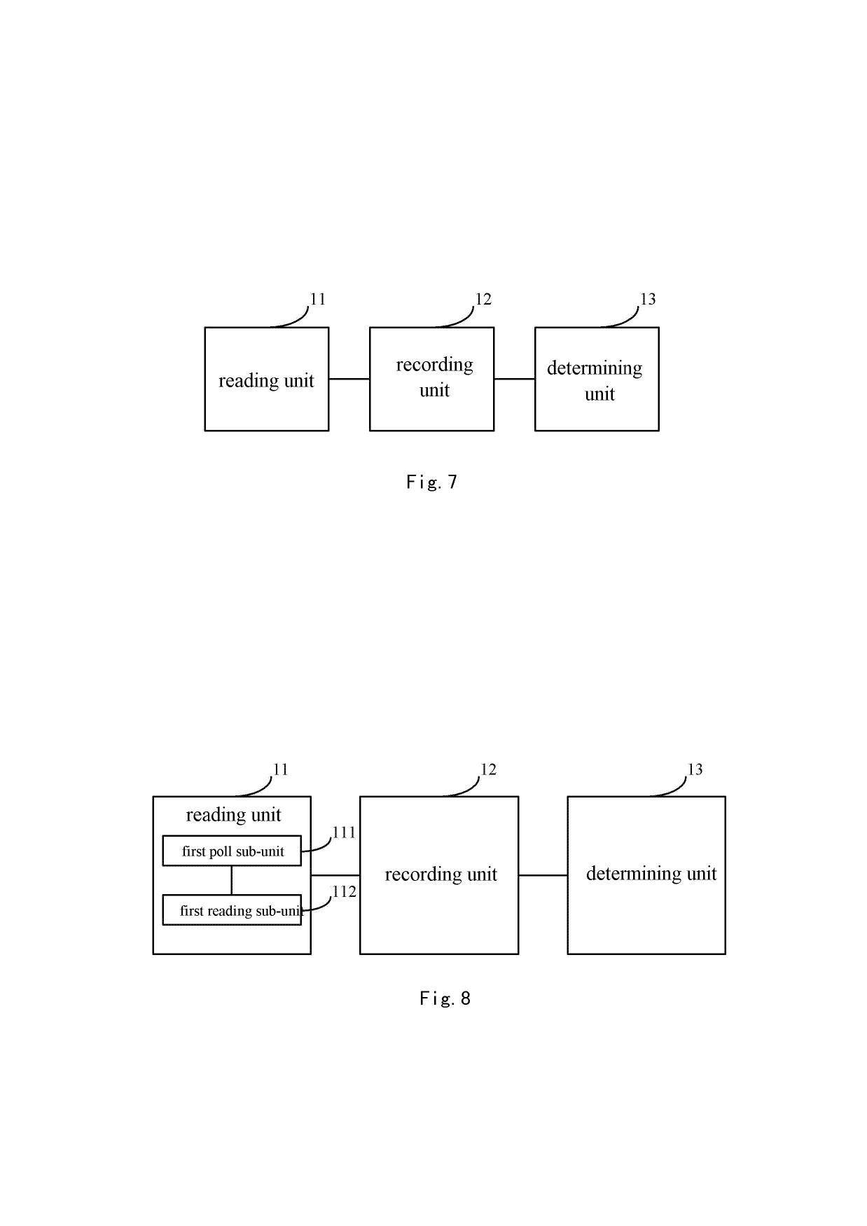

The present disclosure provides a network management device according to an example as shown in FIG. 7, which is for use in a system comprising said network management device, an AC, a Fit AP and a station, with the station hanged under the Fit AP which is under the AC, said network management device comprises:

a reading unit 11 to read station information under said AC when said network management device is initialized;

a recording unit 12, connected to said reading unit 11, to record the online duration of said station; and

a determining unit 13, connected to said recording unit 12, to determine new online duration of said station according to the online duration of said station recorded by said recording unit and the time interval since the last time the online duration was updated.

FIG. 8 shows the structure of a network management device according to another example. This device is substantially same as the device shown in FIG. 7 except that the reading unit 11 further comprises:

a first polling sub-unit 111 to poll said AC when said AC is unreachable; and

a first reading sub-unit 112, connected to said first polling sub-unit 111, to read the station information under said AC when said AC is reachable.

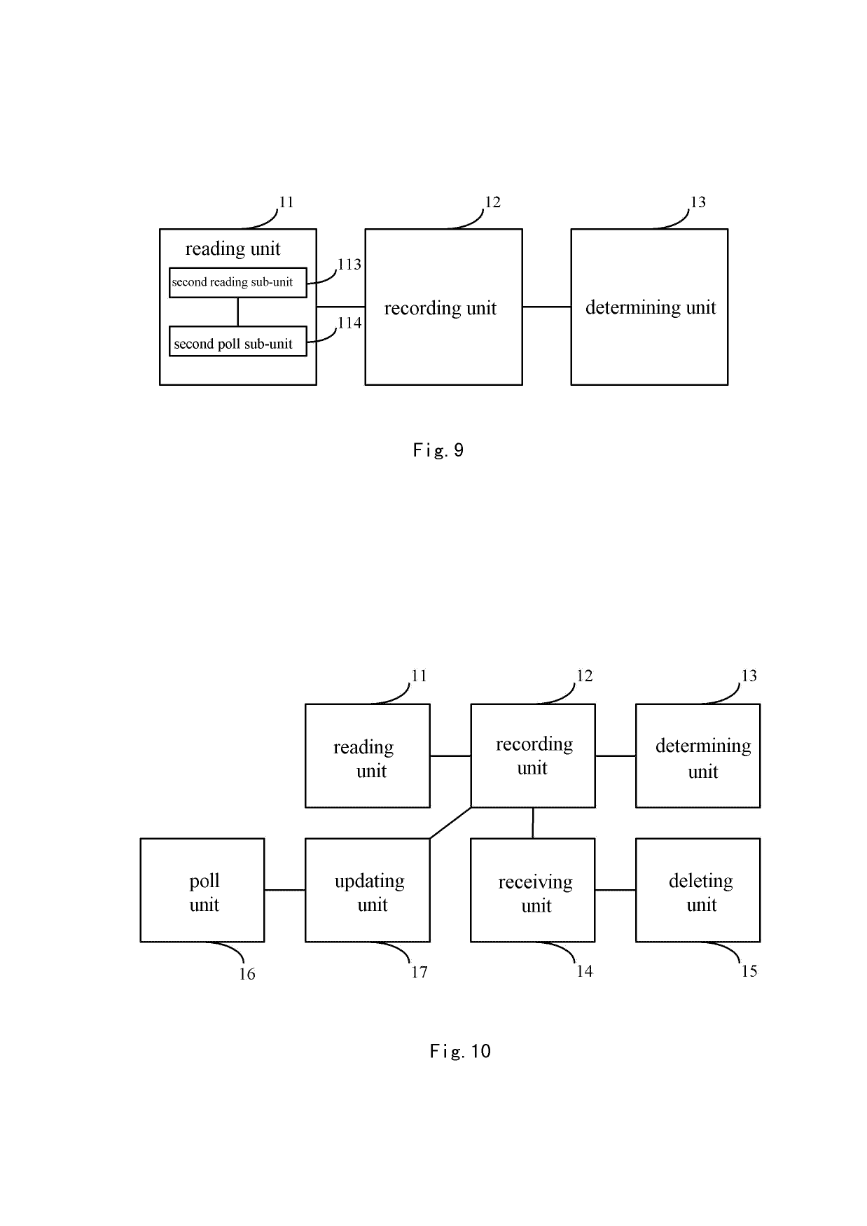

FIG. 9 shows the structure of a network management device according to yet another example. This device is substantially same as the device shown in FIG. 7 except that, the reading unit 11 further comprises:

a second reading sub-unit 113 to read the alarm notification identification bit of said AC; and to read the station information under said AC after said alarm notification identification bit identifies that said AC has configured an alarm notification;

a second polling sub-unit 114, connected to said second reading sub-unit 113, to poll the alarm notification identification bit of said AC when said alarm notification identification bit identifies that said AC has not configured an alarm notification.

FIG. 10 shows the structure of a network management device according to yet another example. This device is substantially same as the device shown in FIG. 7 except that, the network management device further comprises:

a receiving unit 14 to receive an online alarm notification and an offline alarm notification for the station sent by the AC;

said recording unit 12, connected to said receiving unit 14, to record the starting time of the online duration of the station according to said online alarm notification;

a clearing unit 15, connected to said receiving unit 14, to clear the recorded station information according to said offline alarm notification.

a polling unit 16 to poll the station information under said AC according to a preset time;

an updating unit 17, connected to said polling unit 16, to update the station information recorded by itself according to the station information acquired by the polling of said polling unit 16.

With the network management device provided by the present disclosure, the network management device determines new online duration of a station according to the recorded online duration of the station and the time interval since the last time the online duration was updated without needing to interact with the AC frequently to obtain the online duration of the station, thus reducing the load on the AC and being beneficial in improving the Fit AP access capability of the AC.

From the above depiction of the implementation mode, the above examples can be implemented by hardware, software or firmware or a combination thereof. For example the various methods, processes and functional units described herein may be implemented by a processor (the term processor is to be interpreted broadly to include a CPI, processing unit, ASIC, logic unit, or programmable gate array etc.) The processes, methods and functional units may all be performed by a single processor or split between several processers. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

1. A method for acquiring station information for use in a system comprising an access controller (AC), a Fit Access Point (Fit AP), a station and a network management device, with the station hanged under the Fit AP which is under said AC, wherein,
reading the station information under said AC by said network management device when it is initialized;
determining, by said network management device, new online duration of said station according to the recorded online duration of said station and the time interval since the last time the online duration was updated; and
displaying and recording, by said network management device, the new online duration of said station.

2. The method of claim 1, wherein reading the station information under said AC by said network management device comprises: reading the station information under said AC after said network management device has found that said AC is reachable.

3. The method of claim 1, wherein reading the station information under said AC by said network management device comprises: reading by said network management device an alarm notification identification bit of said. AC, if said alarm notification identification bit identifies that said AC has not configured an alarm notification, then polling the alarm notification identification bit of said AC, and reading the station information under said AC if said alarm notification identification bit identifies that said AC has configured an alarm notification.

4. The method of claim 1, comprising:
receiving by said network management device an online alarm notification and an offline alarm notification for the station sent by said AC;
recording by said AC the starting time of the online duration of the station according to said online alarm notification; and
clearing by said AC the recorded station information according to said offline alarm notification.

5. The method of claim 1, comprising:
polling by said network management device the station information under said AC according to a preset time, and updating the station information recorded by itself according to the station information obtained by the polling.

6. A network management device for use in a system comprising said network management device, an AC, a Fit AP and a station, with the station hanged under the Fit AP which is under said AC, wherein said network management device comprises:
a reading unit to read station information under said AC when said network management device is initialized;
a recording unit, connected to said reading unit, to record the online duration of said station; and
a determining unit, connected to said recording unit, to determine new online duration of said station according to the online duration of said station recorded by said recording unit and the time interval since the last time the online duration was updated.

7. The network management device of claim 6, wherein said reading unit comprises:
a first polling sub-unit to poll said AC when said AC is unreachable; and
a first reading sub-unit, connected to said first polling sub-unit, to read the station information under said AC when said AC is reachable.

8. The network management device of claim 6, wherein said reading unit comprises:
a second reading sub-unit to read an alarm notification identification bit of said AC; and to read the station information under said AC after said notification identification bit identifies that said AC has configured an alarm notification; and
a second polling sub-unit, connected to said second reading sub-unit, to poll the alarm notification identification bit of said AC when said alarm notification identification bit identifies that said AC has not configured an alarm notification.

9. The network management device of claim 6, comprising:
a receiving unit to receive an online alarm notification and an offline alarm notification for the station sent by said AC;
said recording unit, connected to said receiving unit, to record the starting time of the online duration of the station according to said online alarm notification; and
a clearing unit, connected to said receiving unit, to clear the recorded station information according to said offline alarm notification.

10. The network management device of claim 6, comprising:
a polling unit to poll the station information under said AC according to a preset time; and
an updating unit, connected to said polling unit, to update the station information recorded by itself according to the station information obtained by the polling of said polling unit.
